(19) United States
(12) Patent Application Publication
(10) Pub. No.: US 2012/0112825 A1
(43) Pub. Date: May 10, 2012

(54) MODULES FOR AN ACTIVE MAINS FILTER AND ACTIVE MAINS FILTER

(75) Inventors: Alfred Engler, Sigmarszell (DE); Sebastian Liebig, Bodolz (DE)

(73) Assignee: Liebherr-Elektronik GmbH, Lindau (Bodensee) (DE)

(21) Appl. No.: 13/252,507

(22) Filed: Oct. 4, 2011

(30) Foreign Application Priority Data
Oct. 4, 2010 (DE) 102010047452.5
Nov. 18, 2010 (DE) 102010051767.4

(51) Int. Cl. H02J 3/01

(52) U.S. Cl. 327/552

(57) ABSTRACT

A module for an active mains filters for determining reference currents for a subsequent current adjustment control with transformation of the inflowing currents, first determines active power of the load, then directly calculates the reference currents taking into account the active power and the α-β components of the mains voltage. A module for an active mains filter for compensating one or more harmonic currents or voltages using selective signal analysis and an active mains filter for a 3-phase supply mains with a reference module for determining reference currents are also provided.

### BACKGROUND OF THE INVENTION

The invention relates to an active mains filter for the compensation of parasitic effects of nonlinear consumer loads on a supply mains. Furthermore, the invention relates to the required modules which are components of such a mains filter.

The fundamental function of an active mains filter according to the preamble is explained first in reference to the example circuit represented in FIG. 1. Block 1 of FIG. 1 characterizes a 3-phase power supply mains which is switched via corresponding connection lines with a nonlinear consumer load characterized by the block 2. The characteristic of the nonlinear consumer load 2 results in a reactive power between supplier 1 and consumer load 2. In addition, the supply mains 1 is loaded with the harmonic currents generated during the operation of the nonlinear load 2. As countermeasure, an active mains filter 3 is integrated in the circuit, which not only compensates the reactive power, and regulates the power factor, that is the ratio between the active power and the apparent power of the connected consumer load 2, to approximately one, it also compensates individual selected harmonic components to zero.

The indexes a, b and c each stand for a phase of the 3-phase power supply mains 1. The currents ia, ib, ic characterize the currents flowing out of the supply mains 1, to wherein the phase voltage ua, ub, uc of the supply mains is applied. The currents iLa, ilB, iLc characterize the currents that flow into the load 2, and the currents iFa, iFb, iFc characterize the currents that are generated by the filter 3 for the compensation. Moreover, the decreasing voltage at the capacitive load of the active filter 3 is marked UDC.

The size and the weight of the active mains filter 3 depend on whether the aim is to compensate individual harmonic oscillations or the complete reactive power. For the selective compensation of certain harmonic oscillations, lower filter currents are sufficient, which makes it possible to use smaller inductors and semiconductors for the implementation of the filter.

In aviation in particular, it is important to have apparatuses that are as light and compact as possible, because kerosene consumption increases with increasing empty weight of the airplane. The control should therefore limit the required compensation current to a minimum, to maximize the efficiency of the filter in this manner.

This aim is to be achieved on the one hand by the selective compensation of a few harmonic oscillations. On the other hand, it is not necessary to regulate individual harmonic components to approximately zero; rather, one only needs to down-regulate to a certain limit value to comply with the respective standard. For example, if 5% of the fifth harmonic is admissible, then an adjustment control to less than 5% would mean the apparatus is not compliance. The same procedure also applies to filters that compensate the respective voltages. To achieve as high as possible an efficiency, it is sufficient to make available a compensation that is in compliance.

The reliability of the active mains filter is even more important than the weight. The filter must maintain full control at all times, and it must not interfere with other consumer loads. A rapid and robust adjustment control ensuring the basic functions is required.

The problem of the invention is to provide an active filter as well as the required modular filter components which satisfy the above requirements.

### SUMMARY OF THE INVENTION

The problem of the invention is solved by a module for an active mains filter for the determination of the reference currents for the subsequent current control of the mains filter according to the characteristics herein. Additional advantageous embodiments of the module are the object of the description herein.

Accordingly, the module comprises a transformation means for the transformation of the inflowing currents, particularly the inflowing load currents, or of the mains voltages into the rest α-β coordinate system. Subsequently, the active power is calculated from the transformed parameters using computing means. The determination of the active power inside the computing means occurs particularly taking into account the α and β components of the inflowing currents, particularly of the inflowing load currents.

It is preferred to measure the load current iL and the filter current iF using arranged current sensors according to FIG. 1. However, in principle, the position of the current sensors plays no role, since the required third current can be calculated using Kirchhoff's junction rule. The inventive idea of the present invention is thus valid regardless of the selected arrangement of the respective current sensors. However, depending on the position of the sensors, the type or the value of the inflowing currents changes. For example, a transformation of the inflowing mains currents (ia, ib, ic), that is the currents flowing out of the supply mains, is equally possible. For the sake of simplicity, only inflowing load currents (iLa, iLb, iLc) are discussed in the following part of the description, without a resulting unnecessary limitation of the invention.

According to the invention, a second computing means is now provided, which calculates the reference currents directly, taking into account the active power and the α-β components of the mains voltage. In contrast to known reference current modules, it is not the α and β components of a filter current that are determined by the second computing means, rather the required 3-phase reference currents, which are needed for a downstream current control of an active mains filter, are calculated directly. An additional inverse transformation of the α and β components of the generated filter currents back into the 3-phase system is not needed. Instead, the individual reference currents can be used directly by the downstream current control as target filter currents.

Furthermore, the module according to the invention is capable of operating without any mains synchronized installation, for example, a PLL or a Kalman filter.

The transformation into the α-β plane occurs particularly via a Clarke transformation.

It is advantageous to provide a low pass filter downstream of the first computing means. The low pass filter serves to extract the DC component of the determined active power, which is made available to the second computing means.

One can further provide that the second computing means takes into account the component of the voltage adjustment control of the intermediate circuit voltage of an active mains filter. The component of this voltage adjustment control is transmitted with the DC component of the intercalated low pass filter to the second computing means for the calculation of the reference currents.

Moreover, it may also be advantageous to subtract the calculated reference currents from the inflowing load currents, and to apply the obtained difference currents as target currents to a subsequent current control module at the module output.

The generated reference currents are not purely sinusoidal under some circumstances, and consequently the course of the compensation is periodically not optimal. Because the reactive power is not taken into account, a correction of the power factor cannot be ruled out which is however undesirable for some applications. For this reason, it may be advantageous to provide an additional low pass filtering of the calculated reference currents. In this case, an additional low pass filter is provided at the output of the second computing means, which carries out a low pass filtering of the individual calculated reference currents.

It has been found to be particularly advantageous to use a self optimizing low pass filter. Self optimization of the low pass filter in this context means that the filter parameters of the low pass filter with respect to the operating time can be determined automatically as a function of the existing phase shift between mains currents and mains voltages. If the filter parameterization in addition takes into account the mains frequency, then the filter parameters of the low pass filter can be calculated exactly.

The phase shift is preferably calculable from the DC components of the active and reactive power determined by the first computing means.

Vie the active and reactive power, the power factor or the phase shift present in the actual system, between mains currents and mains voltage, is calculated. Via the calculated phase shift and the known mains frequency, the low pass filter is parameterized with respect to the operating time. Consequently, said filter can reproduce the actual phase shift exactly, so that the compensation device in no way compensates the reactive power, rather it is limited to the harmonic components.

The forced damping of the amplitudes of the reference currents by the low pass filter can be compensated preferably by additionally inserted reinforcement elements which are also parameterized with respect to the operating time.

The present invention relates moreover to an alternative implementation of the module for an active mains filter for the determination of the reference currents. According to the characteristics herein, the module comprises a voltage adjustment control for the intermediate circuit voltage of a mains filter, which makes available a load active power. According to the invention, a computing means is provided which calculates the reference currents for controlling the current control module of an active net filter, directly from the active power made available, taking into account the 3-phase voltages of a 3-phase supply mains applied at the input to the module.

In contrast to the known modules for generating the reference currents via the current control of the filter intermediate circuit voltage, it is possible to omit, within the regulation structure according to the invention, any device for synchronization with the mains frequency, that is a PLL, and thus an artificial generation of a sine signal. The active power is not calculated directly; rather it is made available via the adjustment control of the intermediate circuit voltage.

Furthermore, one can provide for an externally supplied load active power to flow into the reference current determination of the module.

It is particularly advantageous to take into account an externally supplied active power, if the module is operated in an active mains filter which compensates only a single consumer load. In this case, it is found to be advantageous if the externally supplied load active power is made available directly by the consumer load by means of an analog or digital signal. The module is designed preferably in such a manner that a load active power made available externally can be taken into account immediately. The dynamics in the calculation of the reference currents of the module is consequently improved considerably.

In an actual system, the phase currents and phase voltages frequently do not have an ideal sinusoidal shape. Since some regulation concepts of active mains filters take the unfiltered phase voltages directly into account in the calculation of the reference currents, only an insufficient compensation power can be achieved, depending on the voltage quality. On this background, a module is proposed for an active mains filter to compensate one or more harmonic currents or voltages according to the characteristics herein. Advantageous embodiments are the object of the description herein. The module has a means for selective signal analysis of the inflowing currents or voltages.

According to the invention, said means is implemented in such a manner that, as desired, one or more harmonic components of the current(s) or voltage(s) can be analyzed, and compensated to a freely selectable value. For the compensation, at least one corresponding current can be determined, which can be used for the correction of the corresponding reference currents of an active mains filter, and preferably added to the reference currents.

As input signal of the means for selective signal analysis, it is advantageous to use the actually flowing mains current which corresponds to the difference from load currents and filter currents. The means for selective signal analysis functions preferably on the basis of an I regulator which down-regulates the actual harmonic content of the phase currents until the desired value is reached.

The means for selective signal analysis preferably comprises a computing means for calculating the target value for the sine and cosine components of the nth harmonic. A positive or negative deviation from the target values determined by the computing means leads to a corresponding correction current which can be added directly to the existing reference current of the active mains filter. As a result, it is guaranteed that the maximum admissible number of harmonic components is not exceeded, and the filter is not loaded unnecessarily by overly precise compensation. Unnecessary losses in the active filter are avoided.

To optimize and improve the dynamic and static behavior of the module for the compensation of the harmonic currents and voltages, it is conceivable to integrate a preliminary control into the selective signal analysis means. As a result, in addition to the calculated correction current, a correction voltage is determined which can be supplied to a subsequent current control of an active mains filter. As a result, the current control receives voltage data which results in a considerable load reduction of the current control.

The presented module for the compensation can be used without restriction for 1-phase or 3-phase systems. Furthermore, the existence of a neutral conductor plays no role in three-phase systems in terms of the proper functioning of the module.

The invention relates moreover to an active mains filter for the compensation of the effects caused by a nonlinear consumer load on a 3-phase supply mains, wherein the filter has at least one reference module for the determination of reference currents, at least one correction module for the compensation of harmonics, and at least one current control module.

The reference module generates reference currents which can be made available directly or indirectly for the subsequent current control module, as target current amplitudes. For the correction of harmonic components in the mains voltage or in the mains currents, a correction module is provided which is designed to generate appropriate correction currents. The corresponding correction currents are also made available directly or indirectly at the input of the current control module together with the reference currents.

The reference module is designed particularly in accordance to one of the above explained embodiment possibilities of the module for the determination of the reference currents. The advantages are clearly the same for the active mains filter as for the mentioned module, and the explanation is therefore not repeated here.

Furthermore, it may be provided that the correction module is implemented according to one of the advantageous embodiments of the module for the compensation of one or more harmonic currents and voltages. In this context as well, the advantages are clearly the same for the active mains filter.

It is possible to provide that the current control module is based on a pulse width modulation of the output voltage. Alternatively, a two-point adjustment control of the current may be advantageous.

Moreover, one or more safety functions may be implemented within the current control module.

The active mains filter according to the invention is particularly suitable for interference elimination in an on-board airplane mains.

### BRIEF DESCRIPTION OF THE DRAWINGS

Additional advantages and details result from the embodiment examples represented in the figures. The figures show:

FIG. 1 an example circuit for the design of a supply mains with nonlinear consumer loads and an active filter,

FIG. 2 a circuit diagram of the active mains filter according to the invention,

FIG. 3 a circuit diagram of the reference module according to the invention for the reference current generation in a first embodiment variant,

FIG. 4 the reference module of FIG. 3 in an enlarged variant,

FIG. 5 the reference module of FIG. 4 with a self optimizing low pass filter,

FIG. 6 a circuit diagram of the reference module for the reference current generation according to a second embodiment variant,

FIG. 7 a circuit diagram of the correction module according to the invention for the correction of the current harmonics,

FIG. 8 a circuit diagram of the means according to the invention for selective signal analysis of FIG. 7,

FIG. 9 a circuit diagram of the means for selective signal analysis according to FIG. 8 with preliminary control,

FIG. 10 a structure of an active mains filter with a correction module according to the designs of FIG. 9, and

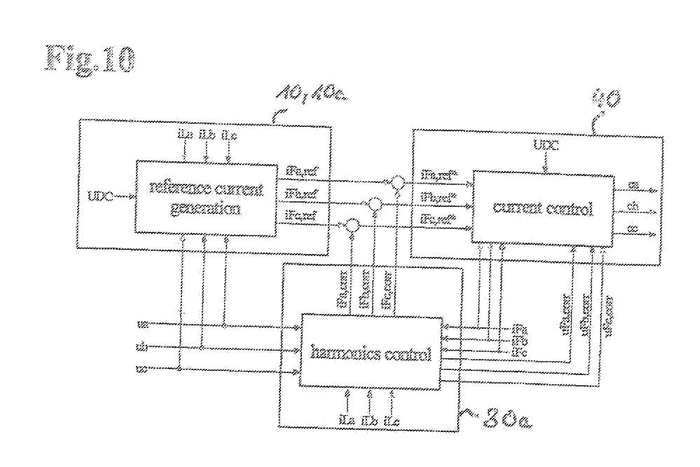

FIG. 11 a circuit diagram [of the] current control module of the active mains filter according to the invention.

### DESCRIPTION OF THE PREFERRED EMBODIMENTS

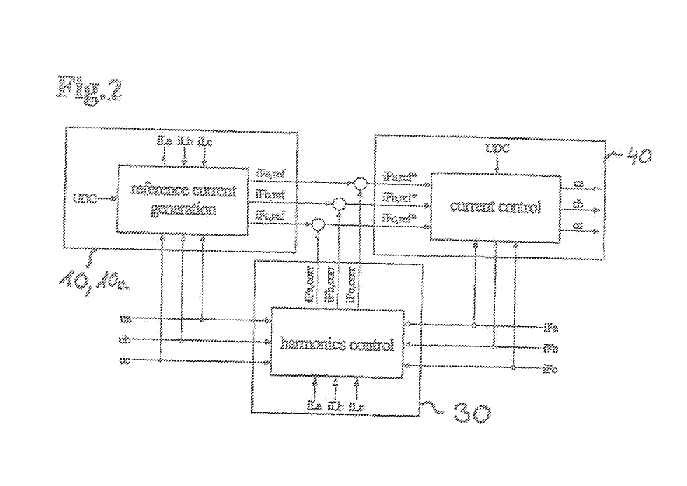

The core structure of the active mains filter according to the invention can be obtained from FIG. 2. The represented filter is used, for example, in the example circuit, instead of the block 3 to compensate possible interferences caused by the nonlinear consumer load 2.

At the input of the reference module 10, the load currents iLa, iLb, iLc as well as the phase voltages ua, ub, uc of the 3-phase supply mains 1 are applied as input parameters. The reference module 10 first generates, taking into account the input parameters, the reference currents iFa,ref, iFb,ref, iFc,ref which are used as current target values for the current control of the three phases a, b, c within the current control module 40. The current control module 40 moreover contains safety functions and a circuit for the generation of the PWM signals which are needed for the actuation of the power components.

In principle, the primary function of the mains filter 3 is already given by the modules 10, 40 alone. However, the reference currents iFa,ref, iFb,ref, iFc,ref are not purely sinusoidal, because the input signals iLa, iLb, iLc are also not sinusoidal. How distorted the reference currents iFa,ref, iFb,ref, iFc,ref actually are depends strongly on the given application. A distorted reference current iFa,ref, iFb,ref, iFc,ref can lead to an insufficient compensation quality. A correction signal iFa,corr, iFb,corr, iFc,corr is needed, which is added to the existing reference signal iFa,ref, iFb,ref, iFc,ref, and the current control target values iFa,ref*, iFb,ref*, iFc,ref* are generated. The correction signals are generated in the correction module 30, namely using the inflowing phase voltages ua, ub, uc of the load currents iLa, iLb, iLc as well as the filter currents iFa, iFb, iFc. The detailed structure of the module is further explained in the following descriptive part.

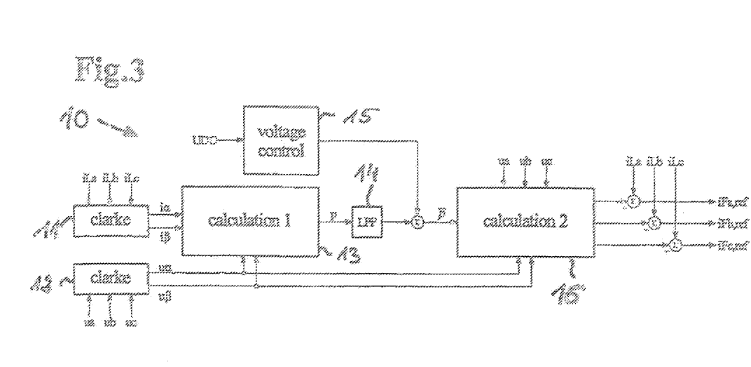

The novel reference module 10 according to the invention for reference current generation is shown in FIG. 3. The load currents iLa, iLb, iLc and the mains currents ua, ub, uc are transformed by the respective blocks 11, 12 into the rest α-β coordinate system. The transformation follows the model of the Clarke transformation which can be defined by the formula

$$[ \begin{matrix}{s}_{α} \\ {s}_{β}\end{matrix} ] = \sqrt{\frac{2}{3} \cdot } [ \begin{matrix}1 & - \frac{1}{2} & - \frac{1}{2} \\ 0 & \frac{\sqrt{3}}{2} & - \frac{\sqrt{3}}{2}\end{matrix} ] \cdot [ \begin{matrix}{s}_{a} \\ {s}_{b} \\ {s}_{c}\end{matrix} ] .$$

In block 13, the active power p is computed using the formula

p=u_{α}i_{α}+u_{β}i_{β}.

The DC component is extracted from the active power using the low pass filter 14. The sum p̅ from the component of the current control 15 for the intermediate circuit voltage UDC of the mains filter and the active power p is made available at the input for the second computing means 16 There, taking into account the phase voltages ua, ub, uc as well as the α and β component of the phase voltages ua, ub, uc using the formulas

$${i}_{a , ref} = \frac{\overline{p} \cdot {u}_{a}}{{u}_{α}^{2} + {u}_{β}^{2}} , \\ {i}_{b , ref} = \frac{\overline{p} \cdot {u}_{b}}{{u}_{α}^{2} + {u}_{β}^{2}} , \\ {i}_{c , ref} = \frac{\overline{p} \cdot {u}_{c}}{{u}_{α}^{2} + {u}_{β}^{2}} ,$$

the target mains currents i_{a,ref}; i_{b,ref}, i_{c,ref} are calculated, and then subtracted from the load currents iLa, iLb, iLc to obtain the filter reference currents iFa,ref, iFb,ref, iFc,ref.

The module according to the invention makes do without any mains synchronized device, such as a PLL or a Kalman filter. Moreover, the module allows the direct calclulation of the three reference currents iFa,ref, iFb,ref, iFc,ref without inverse Clarke transformation.

The generated reference currents iFa,ref, iFb,ref, iFc,ref are not purely sinusoidal, and consequently the compensation cannot occur optimally. Moreover, the reactive power q is not taken into account in the reference module 10 according to FIG. 3, and therefore the filter would not only compensate for harmonics, it would also correct the power factor.

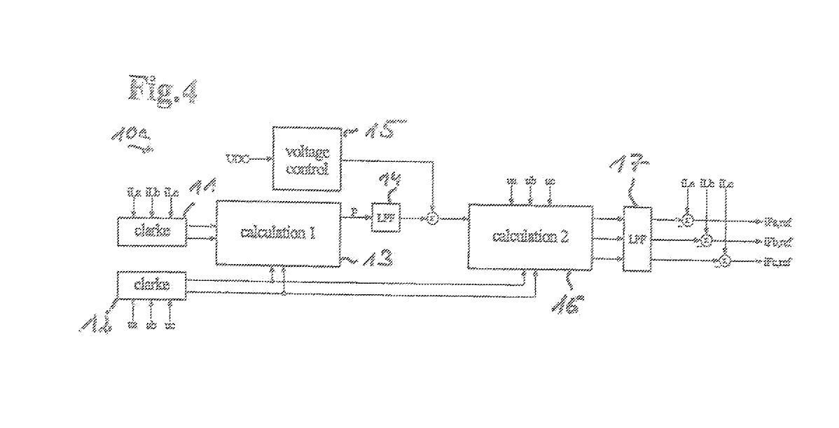

These disadvantages can be avoided by enlarging the reference module 10a according to FIG. 4. Here an additional low pass filter 17 is incorporated, which subjects the calculated target means currents i_{a,ref}, i_{b,ref}, i_{c,ref} to low pass filtering. In principle, it is also possible to filter the mains voltages ua, ub, uc instead of the target mains currents i_{a,ref}, i_{b,ref}, i_{c,ref}.

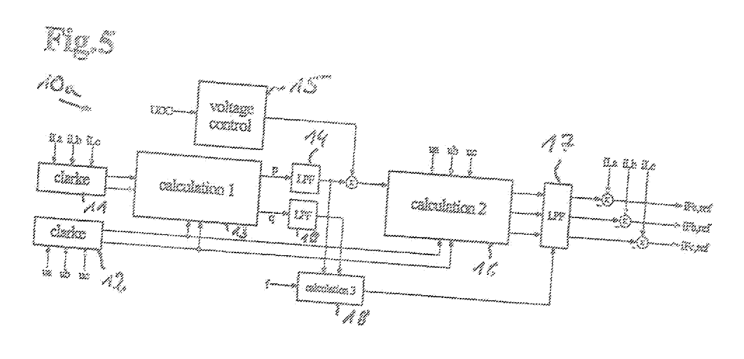

An optimization of the low pass filtering is achieved as soon as the filter parameters during the filter operating time are determined and appropriately adapted. For the filter parameterization, the circuit in FIG. 5 is enlarged by the block 18 which calculates the phase shift between mains currents ic, ib, ic and the mains voltages ua, ub, uc from the DC components of the active power p and the reactive power q. For this purpose, the first computing means 13 additionally determines the reactive power q, the DC component of which is extracted via the low pass filter 19.

If the mains frequency f is known in addition, then an exact and optimal calculation of the filter parameters is guaranteed.

If, instead, the frequency f is known, then the low pass filter 17 remains at its starting parameters, which produces acceptable results for all occurring frequencies. Thus, although the phase shift is unable to occur optimally, and the filter would compensate some of the reactive power q, the quality of the harmonic component compensation is not negatively affected thereby.

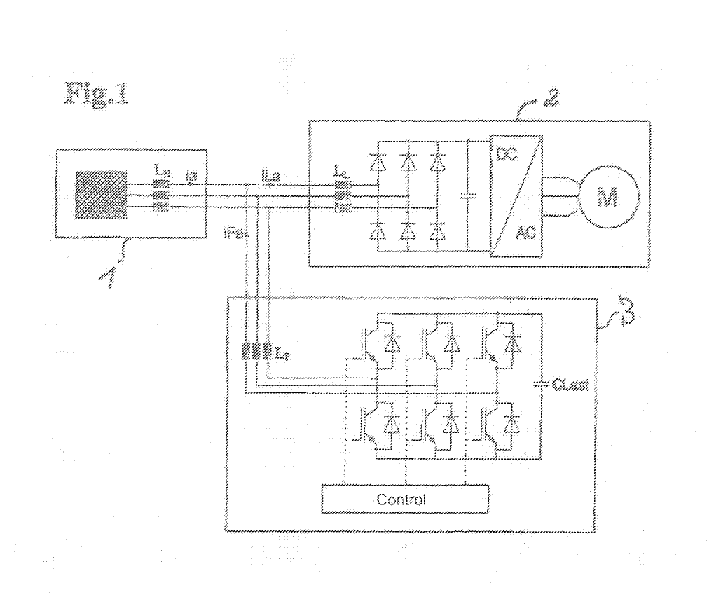

It is preferred to measure the load current iL and the filter current iF according to FIG. 1 by means of arranged current sensors. However, in principle, the position of the current sensors plays no role, since the required third current can be calculated using Kirchhoff's junction rule. The presented fundamental principle of the reference module 10, 10a can be used independently of the position of the sensors; however, the applied input values would change depending on the respective sensor arrangement. For example, by means of an appropriate sensor arrangement in the represented reference module 10 of FIG. 3, the mains currents ia, ib, ic can be subjected to a Clarke transformation, instead of the load currents iLa, iLb, iLc. For the sake of simplicity, only actual embodiment examples with inflowing load currents iLa, iLb, iLc are discussed in the description. However, the invention is in no way limited to them.

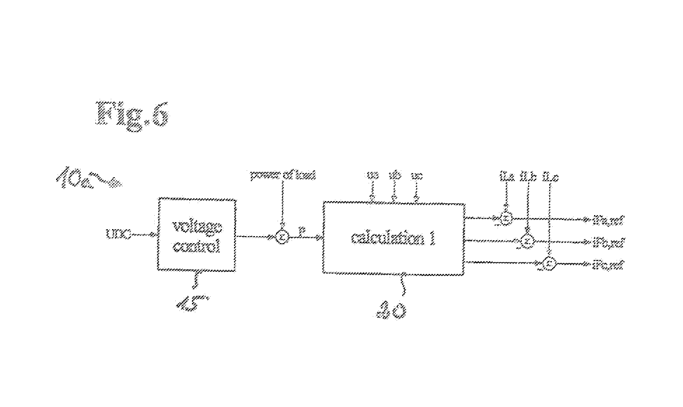

An alternative proposal for the implementation of the reference module 10, 10a is represented in FIG. 6. The power P of the load is not determined by measurement technology, rather it is determined from the voltage adjustment control 15 of the mains filter intermediate circuit. In comparison to similar circuits, the novelty now consists in that a PLL and thus artificial generation of a sine signal are omitted.

Moreover, the possibility is given that the “power of load” load contributes to the adjustment control of the module 10a. This is particularly advantageous if the active mains filter compensates only one consumer load. It receives, from the adjustment control of the consumer load 2, an analog or digital “power of load” signal, and can take it into account immediately. The dynamics of this regulation structure is consequently clearly improved. However, in principle, this regulation structure can get by without additional data on the active power P of the consumer load 2.

The calculation of the target mains currents i_{a,ref}, i_{b,ref}, i_{c,ref} within the module 20 occurs taking into account the power P as well as the phase voltages ua, ub, uc using the formulas

$${i}_{a , ref} = \frac{P \cdot {u}_{a}}{{u}_{α}^{2} + {u}_{β}^{2} + {u}_{c}^{2}} , \\ {i}_{b , ref} = \frac{P \cdot {u}_{b}}{{u}_{α}^{2} + {u}_{β}^{2} + {u}_{c}^{2}} , \\ {i}_{c , ref} = \frac{P \cdot {u}_{c}}{{u}_{α}^{2} + {u}_{β}^{2} + {u}_{c}^{2}} ,$$

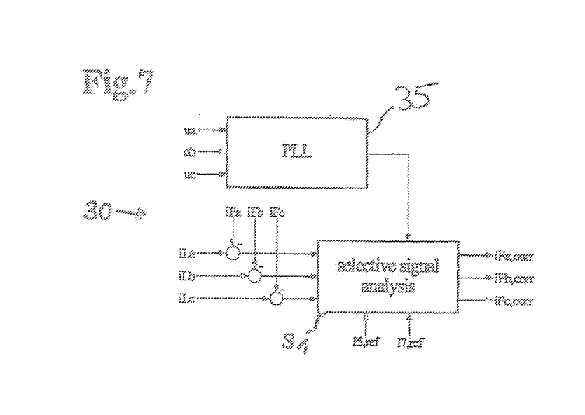

In an actual system, the phase currents and voltages do not have an ideal sine shape. Since known regulation concepts also take into account the unfiltered phase voltages directly in the calculation of the reference currents iFa,ref, iFb,ref, iFc,ref, this can lead, depending on the voltage quality, to an insufficient compensation power. This is remedied by the correction module 30 according to FIG. 7. The function of the module 30 is to determine the residual content of certain harmonic components, and correct the existing reference currents iFa,ref, iFb,ref, iFc,ref. For this purpose, the load currents iLa, iLb, iLc and the filter currents iFa, iFb, iFc are first offset against each other to obtain the actually flowing mains current i.

The result is examined by selective signal analysis with the block 31 for certain harmonic components. The phase-locked loop PLL 35 used serves to control the phase relationship of the voltages ua, ub, uc, and its output is the phase phi.

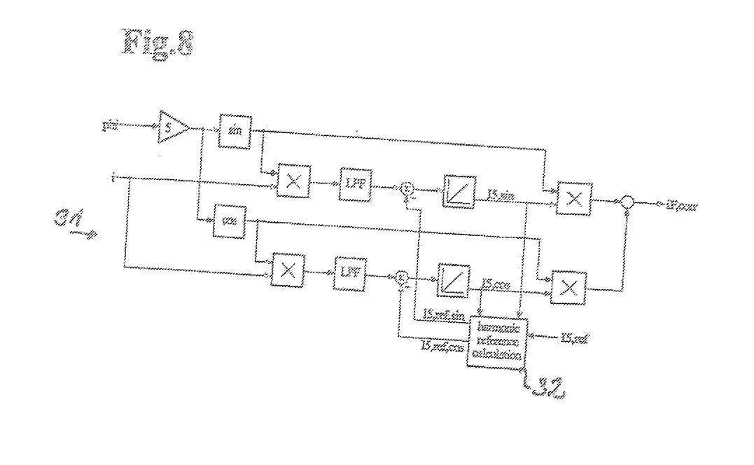

A detailed representation of the block 31 for the selective signal analysis can be obtained from FIG. 8. The structure of the block 31, in represented case, calculates the real and imaginary parts of the fifth harmonic. The calculation of other harmonics occurs analogously. A positive or negative deviation from the target values I5,ref,sin, I5,ref,cos calculated in the block 32 leads to a corresponding correction current iFcorr which, as already explained in FIG. 2, can be added directly to the existing reference current iF,ref. Thus, one ensures that the maximum admissible number of harmonics is not exceeded, and the filter is not loaded unnecessarily by overly precise compensation. For example, if 10 A is admissible for the 5th harmonic, then it would make no economic or technical sense to down-regulate the 5th harmonic to 0 A. This causes only unnecessary losses in the active filter. Instead, using the formulas

$$α = arctan \cdot ( \frac{{I}_{5 , sin}}{{I}_{5 , cos}} ) , \\ {I}_{5 , ref , sin} = {I}_{5 , ref} \cdot sin α , \\ {I}_{5 , ref , cos} = {I}_{5 , ref} \cdot cos α ,$$

or alternatively using the formulas

$${I}_{5} = \sqrt{{I}_{5 , sin}^{2} + {I}_{5 , cos}^{2}} , \\ {I}_{5 , ref , sin} = \frac{{I}_{5 , ref}}{{I}_{5}} \cdot {I}_{5 , sin} , \\ {I}_{5 , ref , cos} = \frac{{I}_{5 , ref}}{{I}_{5}} \cdot {I}_{5 , cos} ,$$

the target value I5,ref,sin, I5,ref,cos for the sine and cosine components of the 5th harmonic is calculated.

The structure of FIG. 8 works like an I regulator and it controls the actual harmonic content of the phase currents ia, ib, ic until the desired value has been reached. The control circuit is closed via the actual circuit.

The substantial innovation in the design of the correction module 30 is particularly the integration of the block 31 which allows a precisely targeted and efficient compensation.

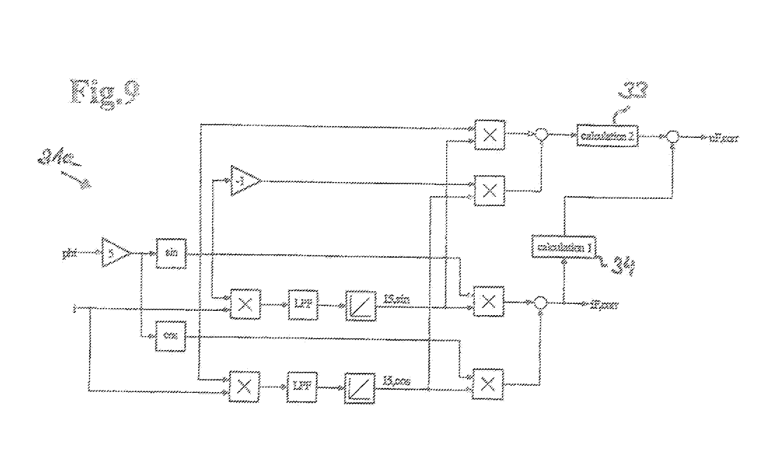

The selective signal analysis can be optimized in the next step. By the integration of a preliminary control, the dynamic and static behavior is improved. The correction module 30a which is modified in comparison to FIG. 8 is represented in detail in FIG. 9. In addition to the signal iF,corr, a signal uF,corr is calculated, which corresponds to the voltage via a filter choke L_{F} (see FIG. 1). The current control module 40 consequently receives voltage data directly, and the load on it is considerably reduced. In principle, it is possible to calculate all the occurring voltage drops at chokes in the block 33, and supply them to the current control. This is particularly important if additional filter elements besides the main chokes are also present. Voltage drops at ohmic resistances are calculated in the block 34.

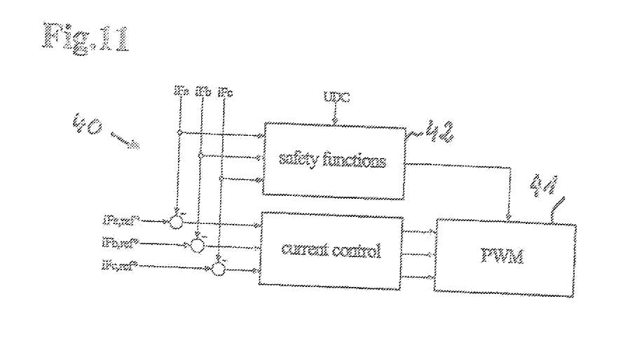

Details of a possible embodiment of the current control module 40 of FIG. 2 can be obtained in FIG. 11. The primary aim of this block is the adjustment control of the filter current iFa, iFb, iFc. For this purpose, the target current (iFa,ref) is compared to the actual value (iFa), and from the difference, a signal is generated which is converted to switching pulses by the block (41) by pulse width modulation (PWM). Said switching pulses are transmitted to the semiconductor switch. The block 42 monitors the filter current iFa, iFb, iFc and the intermediate circuit voltage UDC. In case of excessive current or excessive voltage, the PWM signals are interrupted, and the filter is deactivated.

1. Module for an active mains filter for the determination of the reference currents for a subsequent current adjustment control with a transformation means for transformation, particularly Clarke transformation, of the inflowing currents, in particular of the inflowing load currents and/or of the mains voltages into the rest α-β coordinate system, and for a first computing means for the determination of the active power of the load, wherein
a second computing means is provided, which calculates the reference currents directly, taking into account the active power and the α-β components of the mains voltage.

2. Module according to claim 1, wherein a low pass filter serves to extract the DC component of the provided active power, wherein the DC component can be supplied to the second computing means.

3. Module according to claim 1, wherein the second computing means moreover takes into account the component of the voltage adjustment control of the intermediate circuit voltage.

4. Module according to claim 1, wherein at the output of the module, the difference currents between the calculated reference currents and the inflowing currents, particularly the inflowing load currents, are applied as output signal.

5. Module according to claim 1, wherein an optional low pass filter is provided for subjecting the reference currents to low pass filtering.

6. Module according to claim 5, wherein the optional low pass filter is designed to be self optimizing, preferably by providing that the filter parameters with respect to the operating time can be determined taking into account the phase shift between the mains currents and mains voltages and/or the mains frequency.

7. Module for an active mains filters for the determination of the reference currents for a subsequent current adjustment control with a voltage adjustment control for the intermediate circuit voltage of a mains filter, which makes available a load active power, wherein
a computing means is provided, which calculates the reference currents directly, from the active power made available, taking into account the three phase voltages of a three-phase mains applied at the input on the module.

8. Module according to claim 7, wherein an optionally supplied load active power contributes to the reference current determination.

9. Module according to claim 8, wherein the load active power is made available in analog or digital signal form by a consumer load.

10. Module for an active mains filter for the compensation of one or more harmonic currents or voltages using a means for the selective signal analysis, wherein
using the means for the selective signal analysis, as desired, one or more harmonic components of the current(s) or voltage(s) can be, analyzed, and compensated to a freely selectable value, by providing that at least one corresponding correction current can be determined and delivered.

11. Module according to claim 10, wherein the module can be used in 1- or 3-phase systems with or without neutral conductor.

12. Module according to claim 10, wherein the means of the selective analysis calculates at least one voltage which serves as preliminary control signal for a subsequent current adjustment control of an active mains filter.

13. Active mains filter for the compensation of the effects caused by nonlinear consumer loads on a 3-phase supply mains having at least one reference module for the determination of reference currents, at least one correction module for the compensation of harmonics, and at least one current adjustment control module, wherein the generated reference currents of the reference module and the generated correction currents of the correction module are applied directly or indirectly at the input of the current adjustment control module and taken into account for the current adjustment control.

14. Active mains filter according to claim 13, wherein the reference module is designed according to an active mains filter for the determination of the reference currents for a subsequent current adjustment control with a transformation means for transformation, particularly Clarke transformation, of the inflowing currents, in particular of the inflowing load currents and/or of the mains voltages into the rest α-β coordinate system, and for a first computing means for the determination of the active power of the load, and
a second computing means is provided, which calculates the reference currents directly, taking into account the active power and the α-β components of the mains voltage.

15. Active mains filter according to claim 13, wherein the correction module is designed according to an active mains filter for the compensation of one or more harmonic currents or voltages using a means for the selective signal analysis, wherein
using the means for the selective signal analysis, as desired, one or more harmonic components of the current(s) or voltage(s) can be analyzed, and compensated to a freely selectable value, by providing that at least one corresponding correction current can be determined and delivered.

16. Active mains filter according to claim 13 wherein the current adjustment control consists of a conventional p regulator with or without preliminary control and pulse width modulation of the output voltage, or of a two point regulator, or of a linear regulator, or of another type of current regulator.

17. Use of an active mains filter in particular for interference elimination in an on-board airplane mains.

18. Module according to claim 2, wherein the second computing means moreover takes into account the component of the voltage adjustment control of the intermediate circuit voltage.

19. Module according to claim 18, wherein at the output of the module, the difference currents between the calculated reference currents and the inflowing currents, particularly the inflowing load currents, are applied as output signal.

20. Module according to claim 3, wherein at the output of the module, the difference currents between the calculated reference currents and the inflowing currents, particularly the inflowing load currents, are applied as output signal.
